(19) United States
(12) Patent Application Publication
(10) Pub. No.: US 2002/0116332 A1
(43) Pub. Date: Aug. 22, 2002

(54) System and methods for facilitating a commercial transaction

(76) Inventor: Juan Pablo Sanchez, Mississauga (CA)

Correspondence Address: Fasken Martineau DuMoulin LLP, Box 20, Suite 4200, Toronto-Dominion Centre, Toronto Dominion Bank Tower, Toronto, ON, M5K 1N6, CA

(21) Appl. No.: 10/066,779

(22) Filed: Feb. 6, 2002

(30) Foreign Application Priority Data
Feb. 6, 2001 (CA) 2,334,302

(51) Int. Cl. G06F 17/60

(52) U.S. Cl. 705/39

(57) ABSTRACT

A financing method incorporating a new use of at least one negotiable instrument which is utilized by a buyer (B), a seller (S), and a financial institution (FI), said method comprising the steps of the financial institution concluding an agreement defining the rights and obligations between each set party when the buyer agrees to at least utilize a negotiable instrument recognizable by the financial institution; the buyer and a supplier concluding a transaction where by the supplier supplies goods or services to the buyer for an invoiced amount; the buyer tendering to the supplier a postdated negotiable instrument in the amount of the invoiced value; the supplier presenting the financial institution with the postdated negotiable instrument; the financial institution immediately remitting to the supplier the tendered amount of the negotiable instrument minus a predetermined percentage; the financial institution depositing the negotiable instrument on the due date there for collection in the normal banking system in the same manner as any cheque drawn the buyer's account.

The present invention relates to a method and system for financing a commercial transaction, and more particularly to a new use of negotiable instrument to provide trade credit to a buyer.

### BACKGROUND OF THE INVENTION

In one instance, a commercial transaction consists of a buyer and a seller wherein, the buyer pays the seller for goods or services either with cash or by cheque drawn on the buyers bank. Generally the cheque is dated for the date of the transaction. For one or more reasons, the buyer may issue to the seller a postdated cheque for invoiced goods or services. The invoiced goods or services, creates an accounts receivable for the seller. For various reasons, the seller may decide to sell to a financial institution this accounts receivable for an advance on a portion of the purchase price. The advance given by the financial institution to the seller may depend upon the financial strength of the seller with the balance being paid upon receipt of payment from the buyer.

The above describes one form of accounts receivable financing. It is well known that, traditional accounts receivable financing methods employ a financial institution such as the bank or a factoring company which purchases open accounts receivables from sellers of goods and services. The financial institution may accept a credit risk of the receivable by making the purchase without recourse back to the seller in the event of nonpayment. Alternatively, the purchase is made with full recourse back to the seller in the event that the receivable is not paid when due. One solution around this problem is proposed in U.S. Pat. No. 5,694,552 which describes a financing method incorporating a new use of Trade Acceptance Drafts (TAD).

The TAD described in the above patent differs from factoring in a number of ways. While TADs are based on a new type of negotiable instrument, and resemble a postdated cheque in that on it's due date it is deposited for collection through the normal banking system and processed by the buyer's bank as any other cheque that is drawn against the buyer's account. It is however based on a new negotiable instrument which, creates a direct legal obligation between the buyer and the financial institution but which is not based on a relationship between the buyer and the seller. Consequently, the financial institution requires the TADs of the holder in due course and thus is free of any claims that the buyer may have against the seller. A disadvantage of the TAD described in U.S. Pat. No. 5,694,552 is that a “TAD participation agreement” must be entered into between the seller and the financial institution which defines the rights and obligations of each of these two parties concerning the use of one or more TADs. Furthermore once a TAD participation agreement has been concluded between the seller and the financial institution, the seller solicits participation of buyers. Once a suitable buyer is willing to participate, the buyer and the seller conclude a “TAD program agreement” wherein the seller agrees to sell and/or provide the services to the buyer and the buyer agrees to use TADS as payment for the goods and services.

Accordingly, because of the limitations and difficulties in creating the above agreement, there is a need for a traditional account receivable financing method, which is based on established factoring principles.

### SUMMARY OF THE INVENTION

In accordance with this invention there is provided a financing method incorporating a new use of at least one negotiable instrument which is utilized by a buyer (B), a seller (S), and a financial institution (FI), said method comprising the steps of:

a) the financial institution concluding an agreement defining the rights and obligations between each set party when the buyer agrees to at least utilize a negotiable instrument recognizable by the financial institution;

b) the buyer and a supplier concluding a transaction where by the supplier supplies goods or services to the buyer for an invoiced amount;

c) the buyer tendering to the supplier a postdated negotiable instrument in the amount of the invoiced value;

d) the supplier presenting the financial institution with the postdated negotiable instrument;

e) the financial institution immediately remitting to the supplier the tendered amount of the negotiable instrument minus a predetermined percentage;

f) the financial institution depositing the negotiable instrument on the due date there for collection in the normal banking system in the same manner as any cheque drawn the buyer's account.

According to this invention the FI thus purchases a negotiable instrument from the seller at a discount. This instrument represents a trade credit granted by the seller to the buyer in purchasing goods or services.

The FI assumes the credit risk of the underlying credit sale, the seller pays a discount for prompt payment of the receivable, and the buyer is liable to honor the payment on the due date.

### BRIEF DESCRIPTION OF THE DRAWINGS

Embodiments of the invention will now be described by way of example only with reference to the accompanying drawings in which:

FIG. 1 is a schematic diagram of system according to the present invention.

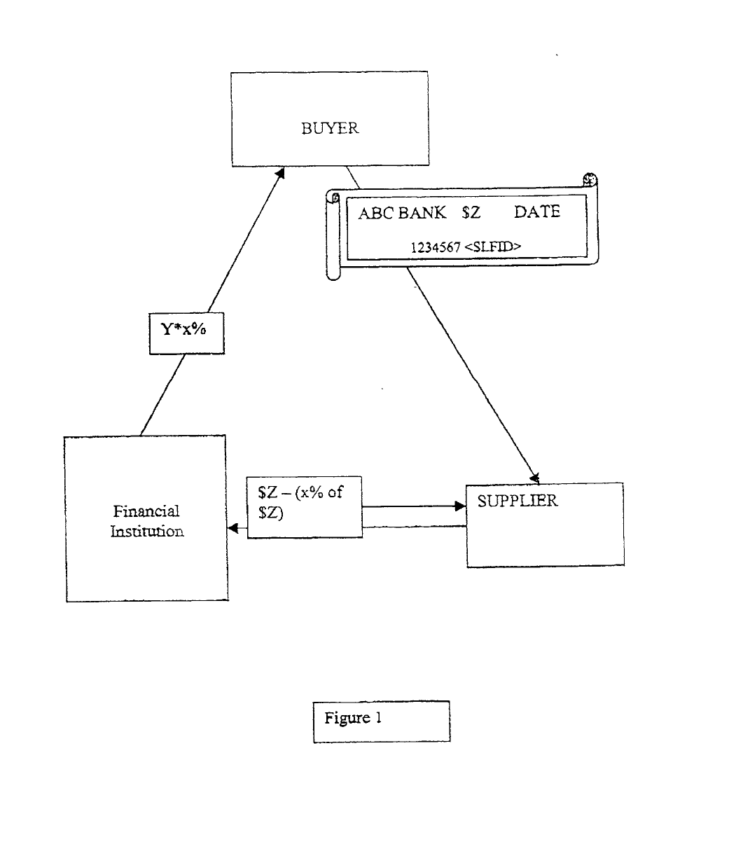

### DETAILED DESCRIPTION OF THE INVENTION

For ease of explanation the following terms as used in the description are defined. A Buyer (B) as an entity that places a purchase order with a Seller (S); the Seller provides goods or services and invoices the buyer for the purchase price. A Financial Institution (FI) is the entity, which purchases from the Seller the negotiable instrument at a discount.

The following terms are also defined:

A Loan is a transaction wherein an owner of a property, called the lender, allows another party, the borrower, to use the property. The borrower customarily promises to return the property after a specified period with payment or its use called interest. The documentation of the promise is called a promissory note when the property is cash.

An Advance is a prepayment received for goods or services to be rendered. Some contracts require an advance before completion. When the business receives an advance payment, it records it as a liability (retainers, deposits, etc.).

A Discount is a reduction in price given for prompt payment.

A Trade Credit is a type of credit extended by one business to another business, allowing the latter to buy goods from the former without making immediate full payment by cheque or with cash. It is credit obtained through open-account purchases represented by an account payable by the buyer and an account receivable by the seller.

A Credit Period is the length of time that credit is granted.

In accordance with the present invention, the buyer and a financial institution enter into an agreement whereby the buyer can tender a negotiable instrument to the seller in exchange for the goods and services from the seller. The negotiable instrument may be a cheque drawn on the buyer's bank account and which includes an identifier recognized and accepted by the financial institution. Apart from the unique identifier, the cheque may be a regular cheque that can be deposited for collection through the buyer's normal bank account and processed by the banking system like any other cheque drawn against a buyer's account.

The buyer then negotiates with the seller for the purchase of the goods and/or services. The seller then provides the goods/or services to the buyer along with a invoice.

The buyer then chooses to pay the invoice by either paying cash or signing a cheque drawn on the buyer's account for the amount of the invoice. The cheque may be postdated to a date agreed to between the buyer and the seller. Depending on the type of goods or services, this may be, 30 days, 90 days or longer.

In this instance, the seller now has an account receivable with regard to the amount to the postdated cheque. If the cheque is of the type according to the present invention, the seller may present the cheque for immediate payment to the financial institution. Because the financial institution recognizes this cheque through the unique identification, as being from a buyer under the above agreed to program, the financial institution will immediately settle the cheque by paying the purchase price minus a discount to the seller.

The percentage discount will generally depend on the amount of the cheque and the discount period. Thus the percentage discount may be higher if the cheque is a 60 day postdated cheque rather than a 30 day postdated cheque.

On the due date of the cheque, the financial institution will deposit the cheque for collection in normal banking system and in the same manner as any cheque drawn on the buyer's account.

As in the above system or program, the seller lowers its receivables and improves its cash flow by obtaining immediate payment from a financial institution. Should the buyer default on payment, the financial institution has recourse directly to the buyer thus removing the seller from any risk from the buyer defaulting. Because of this the buyer can negotiate better terms with the supplier for the goods and services.

Furthermore, the financial institution may also provide a percentage of the discount back to the buyer as incentive to utilize the program according to the present invention.

With the present invention, there are several advantages over traditional factoring in that there is merely a single agreement between the buyer and the financial institution as opposed to agreements between the seller and the financial institution. In other types of accounts receivable financing, such as trade acceptance drafts the seller must submit a trade acceptance draft to the buyer for acceptance by the buyer. In the present invention such a transaction is not required. The buyer may merely tender a cheque upon receipt of the goods and services. Finally, if the supplier receives a cheque according to the present invention, it does not have to concern itself that the cheque will not be purchased by the financial institution as in other systems where in the purchase trade acceptance drafts where in the financial institution will base its decision to purchase the trade acceptance drafts primarily on the financial strength of the buyer. In the present case the buyer has an agreement with the financial institution thus relieving the supplier of creating obligations to the buyer or concerning itself with the buyers credit readiness.

The buyer and FI sign an agreement, but not a loan agreement since the FI is not lending money to the buyer. As a consequence, the buyer does not pay interest unless the buyers cheque is not paid by the buyers bank on the due date.

The FI is not advancing money to the seller, but purchasing at a discount the postdated cheque. If the cheque bounce, the FI has no obvious recourse against the seller.

The terms and expressions which have been employed in the specification are used as terms of description and not of limitations, there is no intention in the use of such terms and expressions to exclude any equivalents of the features shown and described or portions thereof, but it is recognized that various modifications are possible within the scope of the invention.

The embodiments of the invention in which an exclusive property or privilege is claimed are defined as follows:

1. A financing method incorporating a new use of at least one negotiable instrument which is utilized by a buyer, seller and a financial organization, said method is comprised in steps of:
a) a financial institution concluding an agreement defining the rights and obligations between each set party when the buyer agrees to at least utilize a negotiable instrument recognizable by the financial institution;
b) the buyer and a supplier concluding a transaction where by the supplier supplies goods or services to the buyer for an invoiced amount;
c) the buyer tendering to the supplier a postdated negotiable instrument in the amount of the invoiced value;
d) the supplier presenting the financial institution with the postdated negotiable instrument;
e) the financial institution immediately remitting to the supplier the tendered amount of the negotiable instrument minus a predetermined percentage;
f) the financial institution depositing the negotiable instrument on the due date there for collection in the normal banking system in the same manner as any cheque drawn the buyer's account.

2. A method as defined in claim 1, said negotiable instrument being a cheque drawn upon the buyer's bank account.

3. A method as defined in claim 2, said cheque including a unique identification code recognizable by said financial institution.

4. A method as defined in claim 1, said financial institution providing to said buyer a percentage of said predetermined percentage when said negotiable instrument is deposited in said banking system.

5. A method as defined in claim 1, said predetermined discount being determined by the amount of said negotiable instrument and the length of said postdate.
